(19) United States
(12) Patent Application Publication
(10) Pub. No.: US 2025/0236502 A1
(43) Pub. Date: Jul. 24, 2025

(54) ENABLE LOCK FOR MULTI-FUNCTION SINGLE STICK IN BUCKET TRUCK

(71) Applicant: Terex USA, LLC, Norwalk, CT (US)

(72) Inventor: Joel Freidel, Watertown, SD (US)

(21) Appl. No.: 19/032,758

(22) Filed: Jan. 21, 2025

Related U.S. Application Data
(60) Provisional application No. 63/704,761, filed on Oct. 8, 2024.
(60) Provisional application No. 63/622,796, filed on Jan. 19, 2024.

(51) Int. Cl. B66F 17/00

(52) U.S. Cl. CPC B66F 17/006

(57) ABSTRACT

An enable lock mechanism for bucket trucks and aerial work platforms that enhances operational safety by preventing inadvertent activation of a single stick controller's enable lever. The mechanism comprises an enable lock lever, adapter assembly, compression spring, and mounting hardware that work together to provide two distinct operational states. In a rest position, the enable lock mechanically prevents the enable lever from activating the hydraulic circuit while maintaining unrestricted motion of the single stick controller.

### CROSS REFERENCE TO RELATED APPLICATIONS

The present application claims the benefit of the filing date of provisional patent applications having Ser. Nos. 63/622,796 filed Jan. 19, 2024 and 63/704,761 filed Oct. 8, 2024 by Joel Freidel entitled ENABLE LOCK FOR SINGLE STICK IN BUCKET TRUCK, which applications are incorporated herein in their entirety by this reference.

### FIELD OF THE INVENTION

This invention relates to control systems for bucket trucks and aerial work platforms, specifically to safety mechanisms for single stick controllers used to operate boom functions. The technical domain encompasses hydraulic control systems and mechanical safety interlocks for aerial lift equipment used in utility and maintenance operations.

### BACKGROUND OF THE INVENTION

Bucket trucks and aerial work platforms are essential equipment in utility and maintenance operations, employing sophisticated control systems to manage boom functions and platform positioning. Traditional bucket truck control systems utilize single stick controllers that manage various functions through an enable lever system. These controllers typically provide at least the following three functions: upper boom unfold and fold movements, lower boom unfold and fold movement, and clockwise and counterclockwise rotation control. Some bucket truck control systems are well known to provide these three functions as well as an in and out extension function of the upper boom.

The utility industry faces ongoing challenges related to the safe operation of aerial work platforms. Current control systems present several operational concerns including risk of inadvertent activation of the boom.

Consequently, there exists a need for improved methods and apparatuses for efficiently and safely controlling the boom of a bucket truck.

### SUMMARY OF THE INVENTION

It is an object of the present invention to improve the safety of bucket trucks.

It is a feature of the present invention to utilize a safeguard for non-deliberate movement of the boom of a bucket truck.

It is an advantage of the present invention to allow for improved abilities to limit non-deliberate actuation of the boom of a bucket truck.

The present invention provides an innovative enable lever locking mechanism, or enable lock, for bucket truck single stick controllers that addresses safety and operational needs in aerial work platforms. The present invention prevents inadvertent activation of the boom of a bucket truck through a mechanical system that maintains unrestricted controller stick motion while blocking unintended hydraulic circuit engagement.

The enable lock system operates in two distinct states-a rest or locked state that mechanically prevents enable lever activation, and a depressed or unlocked state that permits normal operation. This dual-state functionality ensures that boom operations can only be initiated through intentional operator action.

### BRIEF DESCRIPTION OF THE DRAWINGS

FIG. 1 is an exploded view of the enable lock mechanism showing the adapter enable lock assembly, enable lock lever, compression spring, mounting hardware, and handle core components.

FIG. 2 illustrates a first of two operational states of the enable lock mechanism, the at rest or locked state.

FIG. 3 illustrates a second of two operational states of the enable lock mechanism, the depressed or unlocked state.

FIG. 4 is a side view of a bucket from a bucket truck of the prior art.

FIG. 5 is a side view of a bucket of the present invention with the enable lock of the present invention and with a prior art handle having been detached.

FIG. 6 is an exploded side view of the present invention in a resting or locked state.

FIG. 7 is a view taken online C-C of FIG. 6.

FIG. 8 is a perspective view of the present invention in an at rest or locked configuration.

FIG. 9 is a top view of the present invention where the enable lock hand lever 2 is curved so that it can fit over the outside of handle 7.

### DETAILED DESCRIPTION OF THE PREFERRED EMBODIMENT

Now referring to the drawings wherein like numerals refer to like matter throughout.

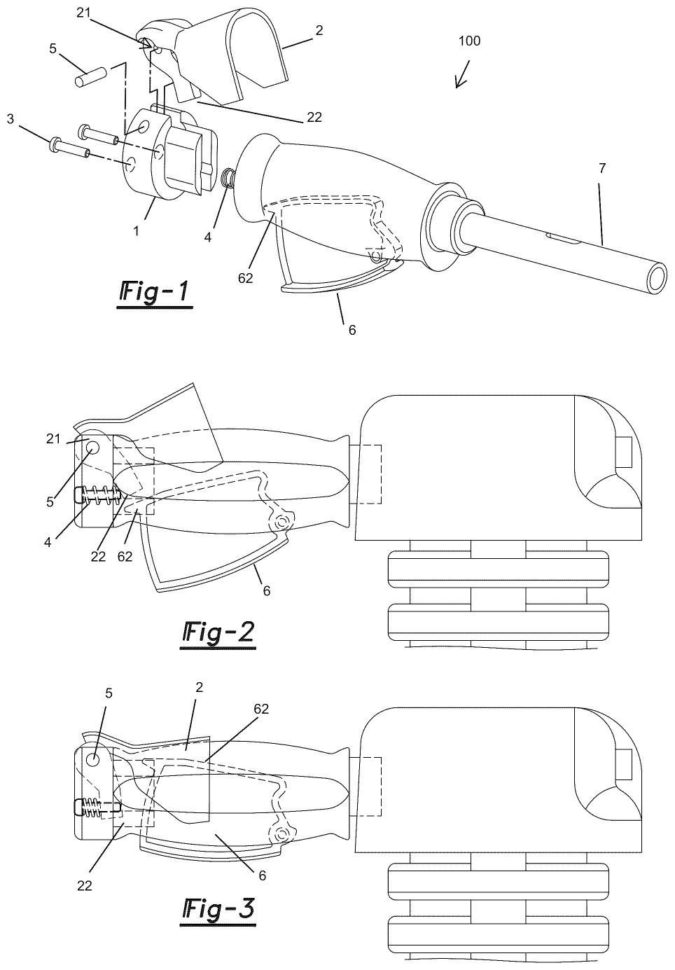

More specifically, in FIG. 1 there is shown a single stick controller of the present invention, generally designated 100 having an adapter enable lock assembly 1, an enable lock hand lever 2, Phillips screws 3; a compression spring 4; an enable lock pin 5, around which enable lock hand lever 2; an enable lever 6, which can be an unmodified prior art enable lever; and a single stick controller handle 7. Adapter enable lock assembly 1 may be an adapter that is made to fit a preexisting prior art handle single stick handle and attached with screws. Compression spring 4 could be (0.36 OD×0.296″ ID) or other suitable springs. Single stick handle 7 could be a handle core with left and right outer shell components.

Now referring to FIG. 2 and FIG. 3, the mechanism of the present invention operates in two distinct states:

FIG. 2 shows the Rest Position which prevents activation of the enable lever 6, by mechanically blocking enable lever 6 from activating a hydraulic circuit, i.e. doing its normal function when fully compressed into a single stick handle 7. Consequently, deliberate actuation of the enable lock hand lever 2 is a required action of a human to unlock the enable lever 6. However, at all times this configuration or rest and locked position also maintains unrestricted physical motion of controller handle with respect to the controller.

Now referring to FIG. 3, there is shown the present invention in a depressed state where the enable lever 6 becomes capable of activation by allowing full movement of the enable lever 6. When in this state normal functioning of enable lever 6 and the single stick controller is permitted.

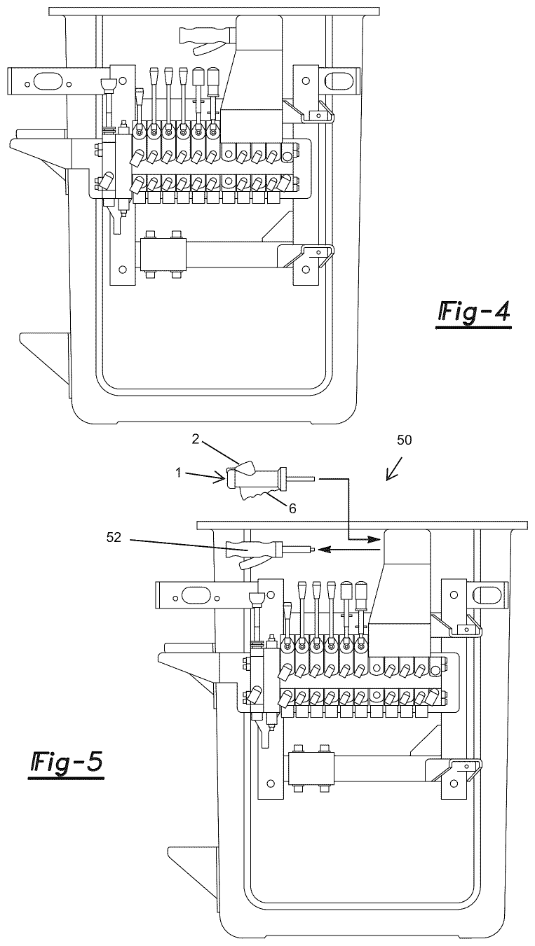

Now referring to FIG. 4, there is shown a prior art bucket with a prior art handle without an enable lock hand lever 2.

Now referring to FIG. 5, there is shown a simple cartoon view of a prior art handle 52 being removed and a new enable lock handle 50 of the present invention.

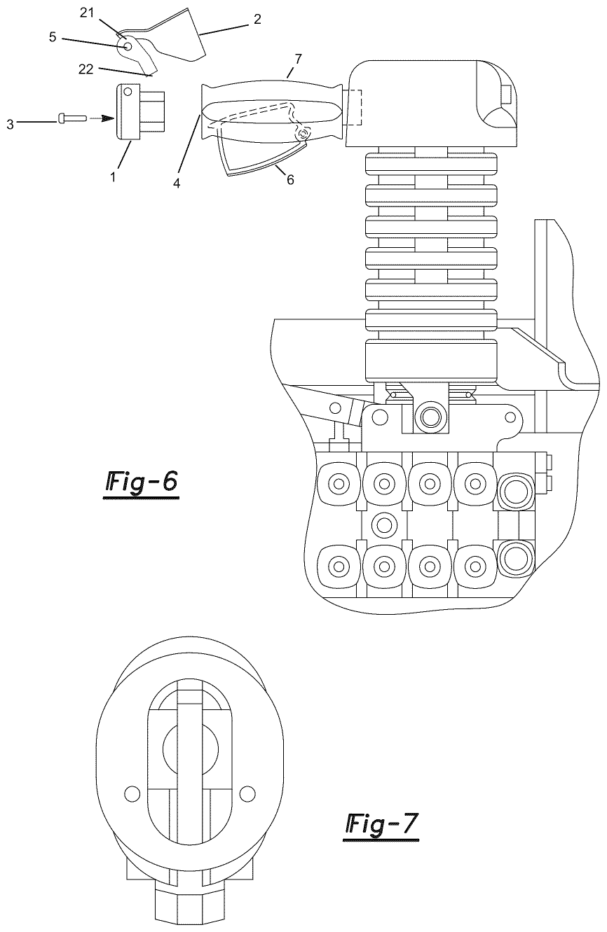

The operation of the present invention is more easily understood by now referring to FIG. 6, which is an exploded side view of the present invention in a resting or locked state. It can be seen that the enable lever internal portion 62 of enable lever 6 is very close to the blocking lever bottom portion 22 of enable lock hand lever 2. If the enable lever 6 were pressed upward; for example by a tree branch, etc., the enable lever internal portion 62 would contact blocking lever bottom portion 22 with only very little and insufficient movement of enable lever 6. However, if there is deliberate human action and the enable lock hand lever 2 is depressed before the enable lever 6 is squeezed, then the enable lever 6 would be allowed to move as normal.

Now referring to FIG. 7, there is a view taken online C-C of FIG. 6.

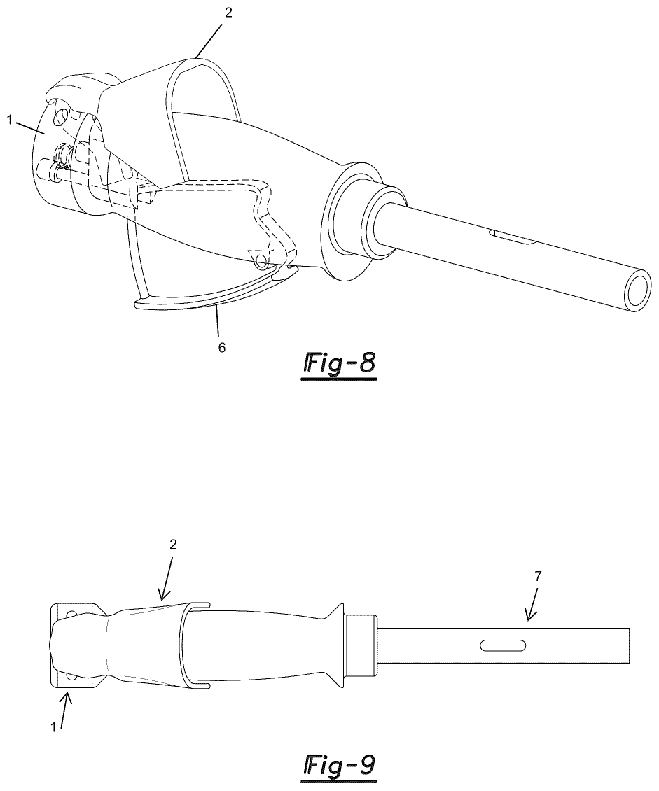

Now referring to FIG. 8, there is shown a perspective view of the present invention in an at rest or locked configuration.

FIG. 9 shows how the enable lock hand lever 2 is curved so that it can fit over the outside of handle 7.

The methods of the present invention are best taught by understanding the differences between FIG. 2 and FIG. 3.

The precise implementation of the present invention will vary depending upon the particular application.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred and/or exemplary embodiment thereof.

1. An enable lock mechanism for a bucket truck of the type having a single stick controller with an enable lever configured to enable a hydraulic circuit, the enable lock mechanism comprising:
an enable lock hand lever 2;
an adapter assembly configured to mount to the single stick controller;
a compression spring operatively connected between the enable lock hand lever and adapter assembly; and
while maintaining unrestricted motion of the single stick controller; the enable lock hand lever mechanically prevents activation of the enable lever 6 unless the enable lock lever is already depressed.

2. The enable lock mechanism of claim 1 wherein the adapter enable lock assembly 1 comprises:
an adapter enable lock assembly body;
a mounting screw for securing the assembly; and
alignment pins.

3. The enable lock mechanism of claim 1 further comprising:
a handle core;
left and right outer shell components enclosing the handle core; and
a blocking lever bottom portion 22 operatively connected to the enable lock hand lever 2.

4. The enable lock mechanism of claim 1 wherein the compression spring has:
an outer diameter of 0.36 inches;
an inner diameter of 0.296 inches; and
a compression length of 0.25 inches.

5. The enable lock mechanism of claim 1 further comprising:
visual indicator lights 53 showing lock engagement status.

6. The enable lock mechanism of claim 1 wherein when enabled, the single stick controller provides:
upper boom control for unfold and fold movements;
lower boom control for up and down movements while maintaining upper boom angle;
rotation control for clockwise and counterclockwise movements; and
upper boom extension control.

7. The enable lock mechanism of claim 1 wherein the enable lock provides:
a rest state where the enable lever cannot activate the hydraulic circuit; and
a depressed state where the enable lever can activate the hydraulic circuit.

8. The enable lock mechanism of claim 1 further comprising:
Phillips pan head mounting screws sized 6-32.

9. The enable lock mechanism of claim 1 wherein the adapter enable lock assembly 1 and enable lock hand lever 2 in combination are configured to:
selectively permit and restrict passage of enable lever internal portion 62 past blocking lever bottom portion 22.

10. The enable lock mechanism of claim 1 wherein the enable lock lever is configured to:
prevent inadvertent hydraulic actuation;
require deliberate operator action for engagement; and
maintain unrestricted physical motion of the controller.

11. A method of operating a bucket truck with a single stick controller comprising the steps of:
providing an enable lock mechanism having an enable lock lever and adapter assembly;
mechanically preventing activation of an enable lever when the enable lock is in a rest position;
maintaining unrestricted motion of the single stick controller while preventing activation; and
permitting activation of the enable lever only upon depression of the enable lock.

12. The method of claim 11 further comprising:
mounting the adapter assembly to the single stick controller using mounting screws;
aligning the assembly using plastic dowel pins; and
installing a compression spring between the enable lock lever and adapter assembly.

13. The method of claim 11 further comprising:
providing visual indication of lock engagement status through enable lock indicator lights.

14. The method of claim 11 wherein operating the single stick controller comprises:
controlling upper boom unfold and fold movements;
controlling lower boom up and down movements while maintaining upper boom angle; and
controlling clockwise and counterclockwise rotation movements.

15. The method of claim 14 further comprising:
extending a portion of the upper boom.

16. The method of claim 11 wherein preventing activation comprises:
mechanically blocking the enable lever from activating a hydraulic circuit;
maintaining physical freedom of controller movement; and
requiring deliberate operator action for engagement.

17. The method of claim 11 further comprising:
integrating the enable lock mechanism with existing hydraulic systems.

18. The method of claim 11 wherein operating the enable lock comprises:
transitioning between a rest position preventing hydraulic circuit activation;
and a depressed position allowing hydraulic circuit activation.

19. The method of claim 11 further comprising:
maintaining enable lock depression during operation;
squeezing a trigger to operate boom functions; and
monitoring visual indicators for system status.

20. An enable lock mechanism for a bucket truck single stick controller comprising:
an enable lock hand lever 2;
an adapter enable lock assembly 1 configured to mount to a single stick controller:
a compression spring operatively connected between a blocking lever bottom portion 22 and a stationary portion of the adapter enable lock assembly 1; and
visual indicator lights 53 showing lock engagement status.
